(19) United States
(12) Patent Application Publication
(10) Pub. No.: US 2013/0176380 A1
(43) Pub. Date: Jul. 11, 2013

(54) Orchestrating an Exchange of Conferencing Transmissions

(71) Applicants: Dirk John Hogan, Corvallis, OR (US); Byron A. Alcom, Fort Collins, CO (US); Richard N. Mckay, Corvallis, OR (US); Mark D. Coleman, Fort Collins, CO (US); Jeffrey Joel Walls, Fort Collins, CO (US)

(72) Inventors: Dirk John Hogan, Corvallis, OR (US); Byron A. Alcom, Fort Collins, CO (US); Richard N. Mckay, Corvallis, OR (US); Mark D. Coleman, Fort Collins, CO (US); Jeffrey Joel Walls, Fort Collins, CO (US)

(21) Appl. No.: 13/348,374

(22) Filed: Jan. 11, 2012

(51) Int. Cl. H04N 7/15; H04L 12/16

(52) U.S. Cl. 348/14.08; 370/260; 348/E07.083

(57) ABSTRACT

A persistent connection may be established between a first and second computing device based on a signal received by the first computing device from the second computing device, where the second computing device is protected by a protective mechanism that blocks unauthorized signals from reaching the second computing device and the signal from the second computing device is allowed by the protective mechanism. A command signal may be sent to the second computing device over the persistent connection, and an exchange of conferencing transmissions may be orchestrated by the first computing device between the second computing device and other computing devices connected to the first computing device.

### BACKGROUND

Video conferencing and other forms of virtual meetings over a network are becoming increasingly popular because such meetings may reduce travel expenses and increase productivity for many organizations. Often, meeting participants may desire to use videoconferencing equipment that is protected behind firewalls and/or other protective mechanisms. These firewalls and/or similar protective mechanisms may interfere with communication signals exchanged during the virtual meeting.

Also, some networks use routers that modify incoming packets. Such technology may be useful when the packets are incompatible with the network's addressing or when the network intends to hide its clients' Internet Protocol (IP) addresses. This modifying of packets while in transit is commonly referred to as network address translation (NAT). NAT also may interfere with inbound signals exchanged during a virtual meeting.

NAT behavior is not standardized throughout the networking industry. Thus, current mechanisms to traverse NAT are often extremely complex.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of an illustrative system for traversing a command signal through a protective mechanism, according to principles described herein.

FIG. 2 is a diagram of an illustrative flowchart of traversing a command signal through a protective mechanism, according to principles described herein.

FIG. 3 is a diagram of an illustrative system for traversing a command signal through a protective mechanism, according to principles described herein.

FIG. 4 is a diagram of an illustrative computing device, according to principles described herein.

FIG. 5 is a diagram of an illustrative method of orchestrating an exchange of conferencing transmissions meeting through a protective mechanism, according to principles described herein.

FIG. 6 is a diagram of an illustrative flowchart of a first computing device orchestrating an exchange of conferencing transmissions, according to principles described herein.

### DETAILED DESCRIPTION

The present specification describes principles including, for example, a method for orchestrating an exchange of conferencing transmissions in a network containing a first computing device and a second computing device, where the second computing device is protected by a protective mechanism that blocks unauthorized signals from reaching the second computing device. Examples of such a method include establishing a persistent connection between the first and second computing devices based on a signal received by the first computing device from the second computing device, the signal from the second computing device being allowed by the protective mechanism; sending a command signal to the second computing device over the persistent connection; and, with the first computing device, orchestrating an exchange of conferencing transmissions between the second computing device and other computing devices in communication with the first computing device.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described is included in at least that one example, but not necessarily in other examples.

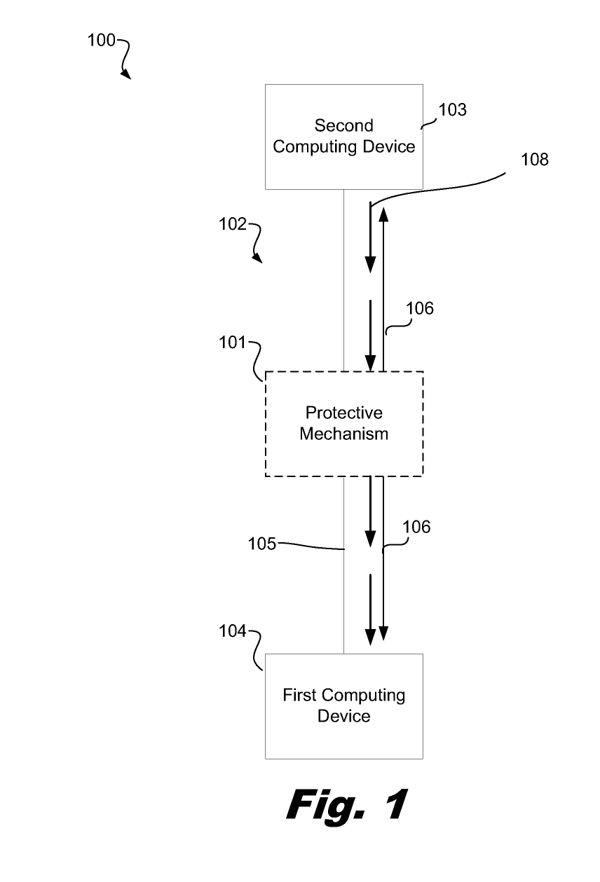

FIG. 1 is a diagram of an illustrative system (100) for traversing a protective mechanism (101) on a network (102). A first computing device (104) and a second computing device (103) may be connected through a signal path (105) on the network, and the protective mechanism may be disposed between second computing device and the first computing device along the signal path.

The protective mechanism (101) may be any hardware device or application with the capability of preventing unauthorized signals from reaching the second computing device (103) or other protected device. In some examples, the protective mechanism (101) may be a firewall, a router, a hardware device or an application that employs network address translation (NAT), or combinations thereof. Generally, the protective mechanism (101) allows signals from trusted sources. However, signals (101) from unfamiliar sources (e.g., first computing device (104)) are generally unauthorized and blocked. In some examples, authorized signals may use encryption or other forms of authentication to pass through the protective mechanism (101).

In some examples, the first and second computing devices may have a client server relationship. Also, in some examples, the first and second computing devices may be part of a peer to peer network.

In the example of FIG. 1, the protective mechanism (101) allows the second computing device's outbound signals (108) to pass through without interference. Thus, the protective mechanism (101) allows outbound communication to devices from which the protective mechanism (101) may not allow inbound communication to the second computing device (103).

The second computing device (103) may send a signal (108) to the first computing device (104) along the signal path (105). Because the signal is sent by the protected second computing device (103), the signal passes through the protective mechanism (101) and successfully arrives at the first computing device (104). Upon receipt of the signal (108), the first computing device (104) uses the received signal to create a persistent connection (106) between the first computing device (104) and the second computing device (103). Because signals from the first computing device (104), as part of the persistent connection, are based on the allowed signal from the second computing device (103), the signals from the first computing device (104) are now allowed by the protective mechanism (101) to reach the second computing device (103).

In some examples, the protective mechanism may read portions of a signal's packet sent from the second computing device. The protective mechanism may learn the intended destination of the second computing device's signal, and protective mechanism may allow response signals from that destination for a reasonable period of time.

The persistent connection (106) may be created in several ways. In some examples, the protective mechanism (101) will keep the connection open between the second computing device (103) and the first computing device (104) for a predetermined time period after the signal (108) connects with the first computing device (104), which may allow signals from the first computing device (104) that would otherwise be blocked. Repeatedly transmitting a signal from the second computing device (103) to the first computing device (104), as shown in FIG. 1, at intervals approximately equal to or less than the predetermined timeout period of the protective mechanism (101) may keep the channel open indefinitely. However, not all protective mechanisms (101) may have the same predetermined timeout period, so signals (108) from the second computing device may be sent more frequently to accommodate for a shorter than expected timeout.

In some examples, a response signal generated by the first computing device (104) may be sent to the second computing device (103) so that the second computing device has confidence that its signal was received by the first computing device (104). In some examples, the protective mechanism (101) may detect the passage of the response signal and reset the predetermined timeout period. Thus, the first computing device (104) and the second computing device (103) may repeatedly resend signals intended to keep the persistent connection (106) alive.

The signals (108) from the second computing device and/or the response signals from the first computing device may contain instructions for how long the persistent connection (106) should remain open. The first computing device (104) or the second computing device (103) may instruct the other to keep the persistent connection (106) open until either the first computing device (104) or the second computing device (103) requests to end the connection. The first computing device (104) or second computing device (103) may request to the other that the persistent connection (106) remain open for a specified period of time. In other examples, the instructions may have the persistent connection end at a certain time of the day. In some examples, the persistent connection (106) may end when the second computing device, or a device associated with the second computing device, is shut down. In some examples, the connection between the second computing device (103) and the first computing device (104) will accommodate a meeting between remote parties, and the instructions may have the persistent connection (106) end when the meeting is scheduled to conclude, when the meeting actually concludes, or a predetermined time period after the meeting ends.

In some examples, the persistent connection may be established through Extensible Messaging and Presence Protocol (XMPP) or other appropriate protocols. Any protocol or mechanism for establishing the persistent connection is within the scope of the principles described herein.

As indicated above, once the persistent connection (106) is established, the first computing device (104) may send unblocked, command signals to the second computing device (103) without interruption from the protective mechanism (101). In some examples, the first computing device may send a video stream, an audio stream, text files, data files, configuration files, executable files, or combinations thereof to the second computing device (103). The first computing device may also send commands over the persistent connection (106) that operate hardware devices or programs associated with the second computing device. For example, the second computing device (103) may be a computer dedicated to videoconferencing and the first computing device (104) may send command signals over the persistent connection (106) to control a graphical interface associated with the second computing device (103). In this way, the first computing device (104) can conduct a videoconference of which the second computing device (103) is a part, even though the second computing device is behind the protective mechanism (101).

The signals from the first computing device (104) to the second computing device (103) over the persistent connection (106) may not require the use of encryption or other forms of signal authentication to pass through the protective mechanism (101). Thus, the first computing device (104) may freely exchange information and commands with other computing devices behind protected mechanisms (101) once a persistent connection (106) is established.

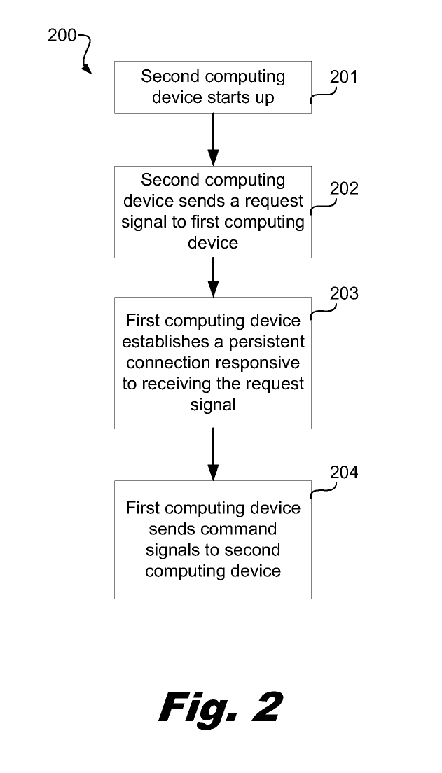

FIG. 2 is an illustrative flowchart of a method (200) for traversing a command signal across a protective mechanism. The first computing device receives (202) a signal from a second computing device separated from the first computing device by a protective mechanism that blocks unauthorized signals. The second computing device may send the signal as the second computing device boots up or when later instructed. The signal may comprise instructions that instruct the first computing device to keep a connection between the first computing device and the second computing device open, thereby, establishing (203) a persistent connection. The first computing device sends (204) command signals to the second computing device or devices associated with the second computing device over the established persistent connection to, for example, conduct a videoconference.

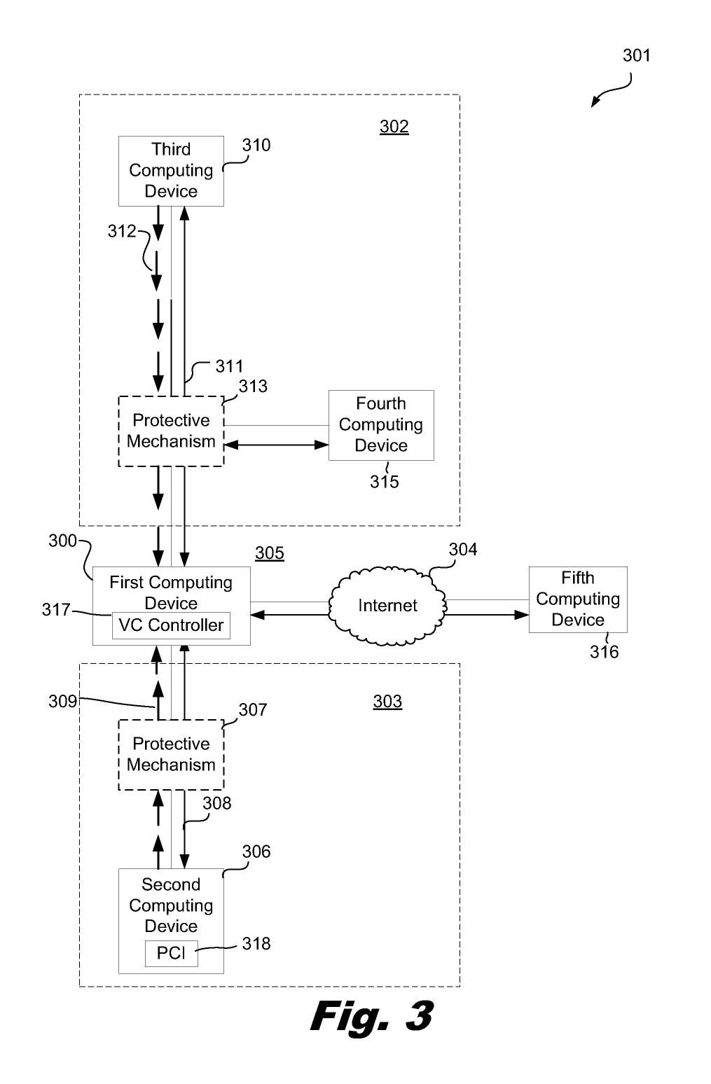

Now referring to FIG. 3, a first computing device (300) may reside within a network (301) that comprises sub-portions (302), (303). The sub-portions may be perimeter sub-networks that utilize protective mechanisms, such as firewalls and NAT technology, to protect the certain computing devices from malicious attacks from the internet (304). The first computing device (300) may reside within an exposed sub-portion (305) of the network (301) that connects sub-portions (302), (303) to the internet (304). A corporation or other organization may divide their network into protected sub-portions with an exposed sub-portion (305) to provide greater security to the sub-portions. The exposed sub-portion (305) may be an additional buffer between the internet and sub-portions (302), (303). Also, if a malicious attack is successful in penetrating one of the sub-portions (302), (303), the other sub-portion may remain protected.

Members of an organization may desire to videoconference with meeting participants at locations scattered across the network (301). In some examples, some locations may fall outside of the organization's network and be connected to the organization's network through the internet (304) or other open networks.

Under such circumstances, the second computing device (306) may be protected by a protective mechanism (307) and the first computing device (300) may establish a persistent connection (308) with the second computing device (306) as described above in relation to FIGS. 1 and 2. The first computing device (300) may establish a persistent connection (311) with a third computing device (310) by receiving signals (312) from the third computing device through the protective mechanism (313). Other computing devices behind the protective mechanism, for example, a fourth computing device (315), may piggyback on the persistent connection (311) formed between the third computing (310) and the first computing device (300).

When multiple computing devices share a persistent connection, the computing devices may provide redundancy to maintain the persistent connection. In some examples, the third computing device (310) may no longer maintain the persistent connection (311) due to a failure or ending its session with the first computing device (300). However, if the fourth computing device (315) is still communicating with the first computing device (300), the first computing device (300) may instruct that fourth computing device to send signals with the intent to maintain or reopen the persistent connection (311).

The first computing device (300) may recognize when the third computing device (310) is no longer sending signals (312) that maintain the persistent connection. If the connection is still needed by another computing device, such as computing device (315), the first computing device may have the fourth computing device (315) send signals before protective mechanism (313) times out and closes the persistent connection (311).

In examples where the first computing device needs to act promptly to keep a persistent connection (311) alive, the first computing device (300) may have the fourth computing device (315) send signals before the first computing device (300) expects that the third computing device (310) will break the persistent connection. In some examples, if the signals (312) from the third computing device (310) become weak or inconsistent, the first computing device (300) may command the fourth computing device (315) to maintain the persistent connection (311) and relieve the third computing device (310) from sending signals that maintain the connection (311).

A fifth computing device (316) located outside of the organization's network (301) may connect to the first computing device over the internet (304). Such a computing device may or may not be protected by a protective mechanism. In examples, where the fifth computing device (316) is unprotected, the first computing device (300) may connect directly to the fifth computing device (316). In this situation, the first computing device (300) may initiate the interaction without any action by the fifth computing device (316). In examples where the fifth computing device (316) is behind a protective mechanism, the first computing device (300) may establish a persistent connection with the fifth computing device (316) in accordance with any of the methods described above.

The first computing device (300) may comprise a videoconferencing controller (317) that orchestrates videoconferencing between multiple computing devices. The first computing device may control the videoconferencing configurations of one or more computing devices. For large organizations, that may require hundreds to thousands of computing devices controlled by a single first computing device.

Meeting orchestration is a process by which a person, unit, or program controls the exchange of conferencing transmissions. Thus, under an orchestration format, the computing devices connected to the first computing device may not command the each other. The first computing device may process all of the input from these computing devices and make decisions about videoconference configurations. Once the first computing device makes a decision, the first computing device may send corresponding commands to the other computing devices to execute those decisions.

Some of the computing devices may be dedicated to videoconferencing. These dedicated computing devices may request a connection with the first computing device as they are turned on or otherwise programmed. In some examples, some computing devices may have a Persistent Connection Initiator (PCI) (318) that is configured to send request signals to the first computing device (300).

The PCI may be activated as dedicated computing devices boot up or as the PCI is otherwise programmed. For example, a videoconference may be scheduled in the organization's scheduling program to take place in a videoconferencing room connected to the network. As the start time for the videoconference approaches, the scheduling program may send a command to the PCI to start. The PCI may also be configured to start at consistent times during a day, week, or other time period. In some examples, the PCI may be manually activated.

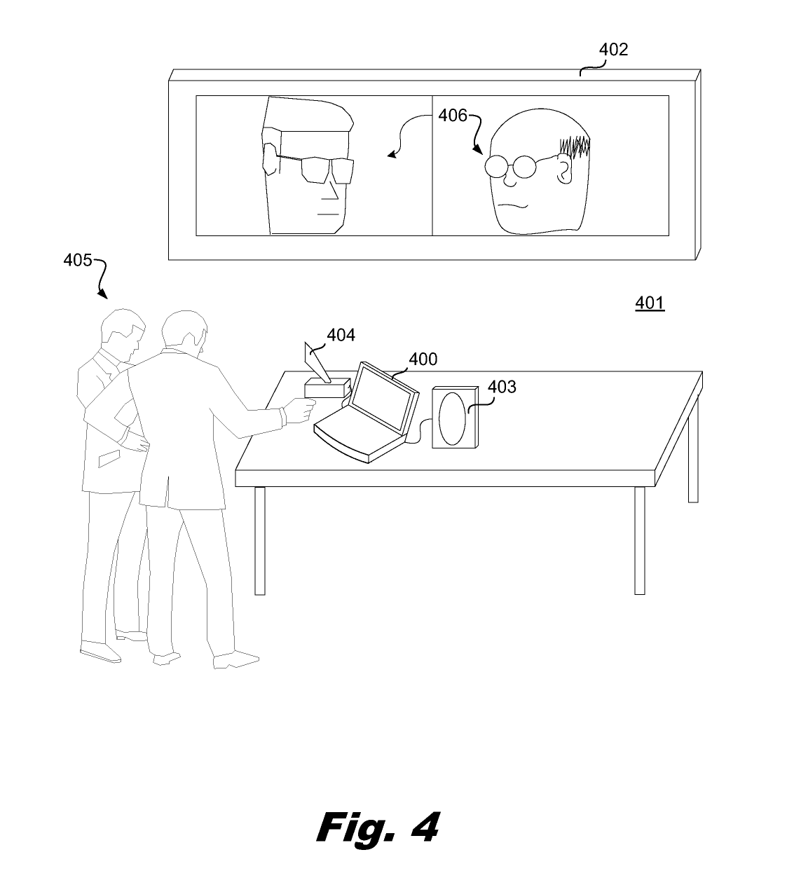

FIG. 4 is a diagram of an illustrative second computing device (400) located in a videoconference room (401). The second computing device may be located in a computer, such as a laptop or desktop. The second computing device may be connected to output devices, like speakers (403) and graphical interfaces. Suitable graphical interfaces may comprise projectors and/or digital monitors (402). The second computing device may also be connected to input devices, like microphones (404), cameras, a keyboard, mouse or other cursor control. Local meeting participants (405) may interact with the input and output devices as though these devices are the remote meeting participants (406).

In some examples, a single computing device may directly interface with all of the input and output devices and relay commands sent from the first computing device. In other examples, multiple computing devices may interact with one or more input and output devices. In some examples, the input and output devices may interface directly with the first computing device.

To orchestrate a videoconference meeting, the first computing device may need to control the input and output devices. In some videoconferences, documents, schematics, 3-D models, whiteboards, or other exhibits may be displayed and manipulated during the conference. The videoconferencing controller located in the first computing device may receive input from the camera, microphones, and computers. Codecs associated with the computing devices may compress some of these inputs into data streams and transmit them to the first computing device. The videoconferencing controller may determine from the data streams or other inputs which meeting participant is speaking and if any exhibits are intended for display. After determining the speaker, the speaker's location, and if any exhibits should be displayed, the videoconferencing controller directs at least some of the data streams and corresponding commands to appropriate computing devices. The data streams may be decompressed by the codecs and converted into useable audiovisual output for the meeting participants at each location.

However, in some examples, not all of the data streams are routed in the same manner to all video conferencing locations. For example, a data stream containing audiovisual data from one location may not be routed back to that same location. Meeting participants may feel awkward or distracted by viewing themselves on a graphical interface. However, a document presented for display at a location may also be routed back to its original location for the convenience of the local meeting participants.

In some examples, the first computing device may determine the speaker by using voice activation. The first computing device then presents the image of the location that contains the meeting participant that the first computing device has determined is speaking. Once the location of the speaker is determined, the first computing device may direct that location's data stream to the other computing devices. The process may be repeated as the first computing device follows the conversion between speakers at different remote locations. The first computing device may switch between data streams from different locations as the first computing device determines that the person speaking has changed.

The first computing device may switch between different cameras at the same location to frame the presumed speaker better. Also, the first computing device may control a camera angle and zoom to provide a better experience to the users. Further, the first computing device may control a camera angle to follow a moving meeting participate or to focus on a live demonstration.

However, frequent switching may feel unnatural to meeting participants (405). Thus, the first computing device may configure the videoconference experience to make the meeting participants feel as though they are in the same room with their remote counterparts (406). This presence mode may display each meeting participant on a graphical interface in a natural manner. As participants join and leave the meeting, the first computing device may reconfigure the graphical interface to reflect the changes.

For example, in FIG. 4, two remote meeting participants are shown on a digital monitor (402) at the same time. Each remote participate occupies a large surface area so the remote participants (406) appear to be life size. However, if a third remote meeting participant joins the meeting, the images of the current remote meeting participants may be shrunk to make room for an image of the third participant. The first computing device may instruct the digital monitor (402) to adjust whenever a meeting participant joins or leaves the videoconference.

However, presence mode may be overwhelming for videoconference sessions with hundreds of participants. In such videoconferences, only a few meeting participants are likely to actively participate in the videoconference, while other meeting participants will likely be spectators. In this type of situation, a voice activation mode may be more natural for participants. Based on the input provided, the first computing device may select a mode that appears well suited for the videoconference's circumstances.

In some examples, the first computing device may control the timing of the video and audio streams to reduce or eliminate offset delays between them. In addition to merely timing the presentation of video streams with the audio streams so that the audio broadcasts in real time with the video stream, the first computing device may also adjust the timing of audio visual streams from different locations. For example, data streams coming from meeting locations located farther away than other meeting locations may have more latency. Thus, the first computing device may delay some data streams to make the videoconference experience more natural.

Also, the first computing device may need to adjust the speaker volume during the videoconference. In some examples, some meeting participants may be located closer to a microphone than other meeting participants. The first computing device may instruct the other computing devices to repeat, boost, clean up, mute, and/or amplify the speech of certain meeting participants while leaving other participant's speech unaltered. In some examples, the first computing device may instruct the speakers to lower the volume of a certain speaker. Also, some locations may provide a better sound quality than others, and the first computing device may adjust the audio streams accordingly.

Further, the first computing device may recognize background noise produced at a certain location, such as a passing train or crinkling of a sandwich wrapper that may overwhelm the audio input devices at that location. The first computing device may refrain from transmitting those data streams to other locations, filter out a speaker from that location and send a filtered audio stream, or minimize the background noise by focusing the audio input device on speaking meeting participants. Also, the first computing device may instruct the audio input devices to cancel out echoes produced from the audio output devices at the same location.

A centralized, first computing device that controls all of the other computing devices involved with a videoconference may benefit the meeting participants because all factors, such as incoming and outgoing meeting participants, data stream timing, quality of data streams, and others factors can be considered by a single unit. This enables the first computing device to orchestrate between the different connected computing devices and their associated input and output devices to provide a quality experience for all meeting participants.

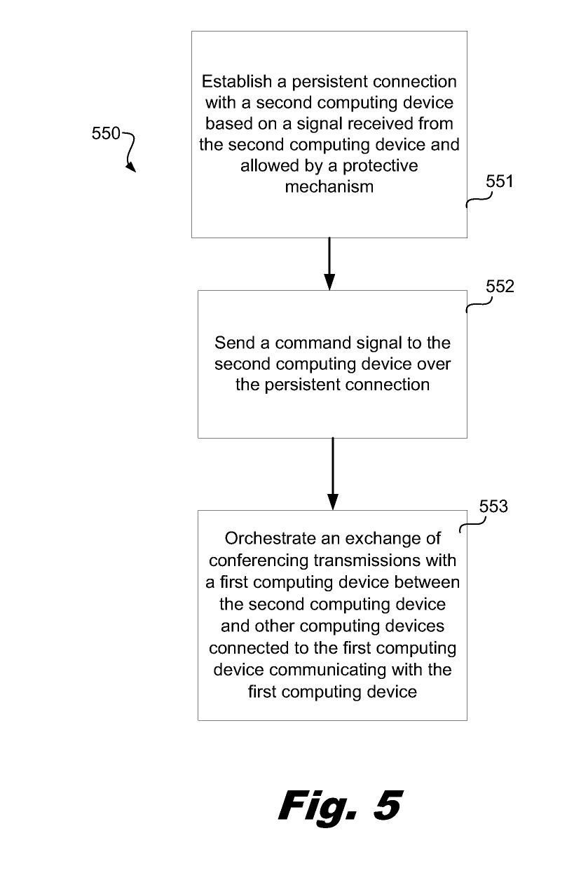

FIG. 5 is a diagram of an illustrative method (550) for orchestrating an exchange of conferencing transmissions through a protective mechanism in a network with a first computing device and a second computing device, the second computing device being protected by a protective mechanism that blocks unauthorized signals from reaching the second computing device. This method includes establishing (551) a persistent connection by having the computing device send a signal to the first computing device. Because the signal is from the protected second computing device, the signal is allowed by the protective mechanism.

The method continues with sending (552) a command signal to the second computing device from the first computing device over the persistent connection. Because the protected second computing device first contacted the first computing device to establish the persistent connection, the incoming signal from the first computing device is now allowed. Consequently, the method can include orchestrating (553) a meeting by the first computing device between the second computing device and other computing devices connected to the first computing device through the persistent connection.

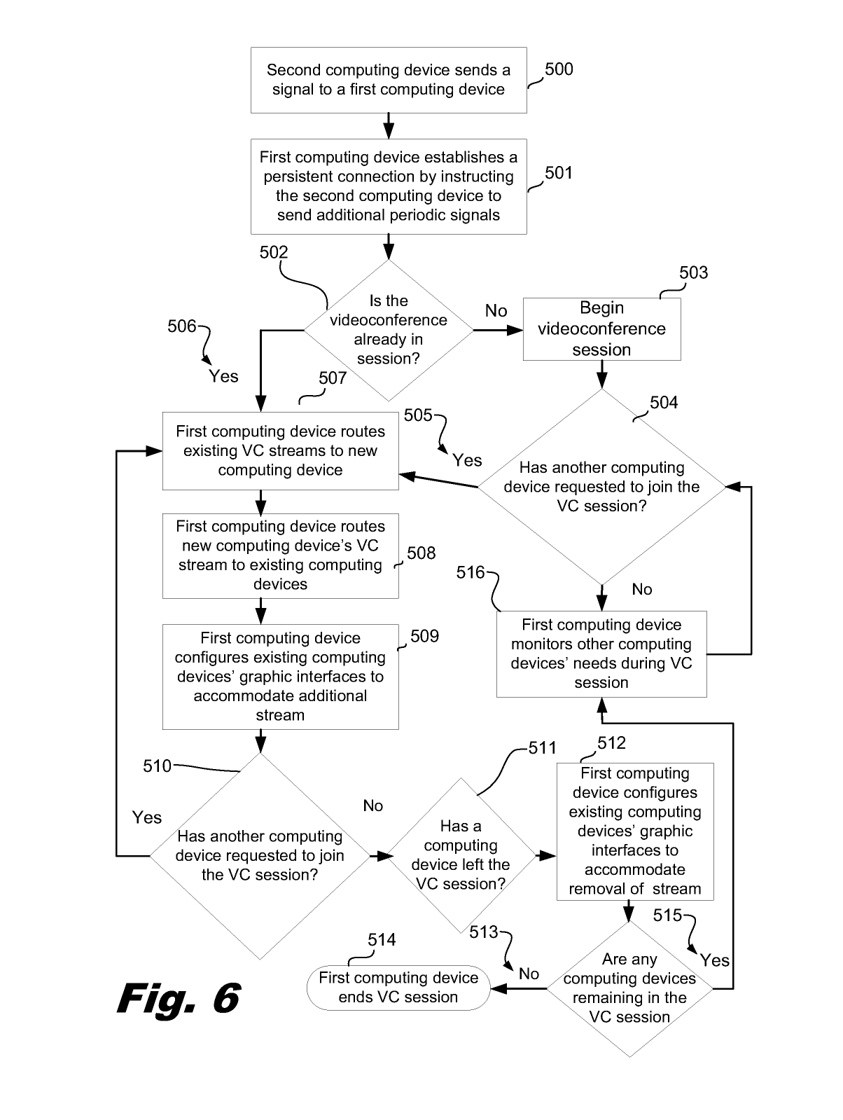

FIG. 6 is a diagram of an illustrative flowchart of a first computing device orchestrating a videoconference with reference to some of the videoconference configuration commands. Other videoconference configuration commands may include commands that deal with conference mode selection, data stream switching, data stream routing, signal timing, audio adjustments, video adjustments, echo cancellation, graphical interface customization, data stream correction and modification, and combinations thereof.

A second computing device may send (500) a signal to the first computing device that allows the first computing device. The first computing device may send instructions to second computing device to send additional periodic signals to keep the connection between the first and second computing devices open, thereby establishing (501) a persistent connection with the second computing device. The first computing device may determine (502) whether a videoconference is already in session. If not, the first computing device may begin (503) the videoconference session.

Next, the first computing device determines (504) whether another computing device is requesting to join the videoconference. Another computing device may request to join the videoconference by sending a signal to the first computing device if the requesting computing device is behind a protective mechanism, or the first computing device may establish a connection in another manner if there no protective mechanism is between the requesting computing device and the first computing device. In some examples, the first computing device may initiate communication with unprotected computing devices. If no additional computing device is requesting to join the videoconference, the first computing device monitors (516) the connected computing devices' needs during the conference and makes adjustments as appropriate.

When an additional computing device requests (505) to join the videoconference or if the videoconference is already in session (506) when the requesting computing device creates the persistent connection, the first computing device may route (507) the existing videoconference data streams to the recently joined computing devices. Also, the first computing device may route (508) the data streams from the recently joined computing devices to the existing computing devices in the videoconference. To accommodate the additional data streams to each of the computing devices, the first computing device may configure (509) each computing devices graphical interface to add visual images from the added computing devices.

When the first computing device determines (510) that yet another computing device requests to join the videoconference, the process of routing (507), (508) the data streams and configuring (509) the graphical interface may repeat. If the first computing device determines (511) that a computing device leaves the videoconference, the first computing device may configure (512) the graphical interfaces to reflect the changes.

In the event that the first computing device determines (513) that no computing devices remain in the videoconference, the first computing device may end (514) the videoconference session. If other computing devices remain (515) in the session, the first computing device may continue to monitor (516) the connected other computing devices' needs.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for orchestrating an exchange of conferencing transmissions through a protective mechanism, comprising,
establishing a persistent connection between a first computing device and a second computing device based on a signal received by said first computing device, said first and second computing devices being in a network where said second computing device is protected by a protective mechanism that blocks unauthorized signals from reaching said second computing device, and said signal being sent from said second computing device and allowed by said protective mechanism;
sending a command signal to said second computing device from said first computing device over said persistent connection; and
with said first computing device, orchestrating an exchange of conferencing transmissions between said first computing device and other computing devices communicating with said first computing device.

2. The method of claim 1, further comprising establishing a second persistent connection between said first computing device and a third computing device based on a second signal received by said first computing device from said third computing device, said second signal from said third computing device being allowed by a second protective mechanism.

3. The method of claim 1, further comprising sending command signals from said first computing device to said second computing device based on input from another computing device communicating with said first computing device.

4. The method of claim 1, wherein said protective mechanism comprises a firewall device, a network address translation device, or combinations thereof.

5. The method of claim 1, wherein said command signal is a video conferencing configuration command.

6. The method of claim 5, wherein said video conferencing configuration command comprises a command routing audiovisual streams to accommodate a changing number of computing devices involved in a video conference.

7. The method of claim 5, wherein said video conferencing configuration command comprises a command adjusting a graphical interface of said second computing device to accommodate a changing number computing devices involved in a video conference.

8. The method of claim 1, wherein establishing a persistent connection between said first computing device and second computing device based on a signal received by said first computing device includes establishing a persistent connection through Extensible Messaging and Presence Protocol.

9. A first computing device for orchestrating an exchange of conferencing transmissions involving a second computing device that is communicating over a network and through a protective mechanism with said first computing device, wherein said protective mechanism initially blocks unauthorized signals from said first computing device to said second computing device, said first computing device being programmed to:
establish a persistent connection with said second computing device through said protective mechanism, said persistent connection being based on receiving a signal from said second computing device that, having originated with said second computing device, is allowed by said protective mechanism;
send a command signal to said second computing device over said persistent connection, and
orchestrate an exchange of conferencing transmissions between a said second computing device and other computing devices on said network.

10. The first computing device of claim 9, wherein said command signal is a video conference configuration command.

11. The first computing device of claim 10, wherein said video conferencing configuration command comprises a command adjusting a graphical interface of said second computing device to accommodate a changing number of computing devices involved in a video conference.

12. The first computing device of claim 10, wherein said video conferencing configuration command comprises a command routing audiovisual streams to accommodate a changing number of computing devices involved in a video conference.

13. A computer program product, comprising:
a tangible computer readable storage medium, said computer readable storage medium comprising computer readable program code embodied therewith, said computer readable program code comprising:
computer readable program code to receive a signal received by said first computing device from said second computing device, said signal from said second computing device being allowed by said protective mechanism;
computer readable program code to send instructions to said second computing device within a time period after receipt of said signal allowed by said protective mechanism instructing said second computing mechanism to send additional signals to said first computing device to establish a persistent connection;
computer readable program code to send a command signal to said second computing device with said first computing device over said persistent connection; and
computer readable program code to orchestrate an exchange of conferencing transmissions by said first computing device between said second computing device and other computing devices connected to said first computing device.

14. The computer program product of claim 13, wherein said command signal is a video conference configuration command.

15. The computer program product of claim 14, wherein said video conferencing configuration command comprises a command adjusting a graphical interface of said second computing device to accommodate a changing number of computing devices involved in a video conference.
